(19) United States
(12) Patent Application Publication
(10) Pub. No.: US 2022/0034643 A1
(43) Pub. Date: Feb. 3, 2022

(54) ROTATIONAL SPEED AND/OR ROTATIONAL ANGLE DETECTION UNIT AND WORKING DEVICE

(71) Applicant: Robert Bosch GmbH, Stuttgart (DE)

(72) Inventor: Rolando Doelling, Hechingen (DE)

(21) Appl. No.: 17/276,728

(22) PCT Filed: Nov. 29, 2019
(86) PCT No.: PCT/EP2019/083007

§ 371 Date: Mar. 16, 2021

(30) Foreign Application Priority Data
Dec. 7, 2018 (DE) 10 2018 221 211.2

(51) Int. Cl. G01B 7/30; G01D 5/20; G01P 3/481; G01L 3/10; B62J 45/413

(52) U.S. Cl. CPC G01B 7/30; G01D 5/20; B62J 45/413; G01L 3/105; G01P 3/481

(57) ABSTRACT

A rotational speed and/or rotational angle detection unit for detecting a rotational speed and/or a rotational angle of a shaft, in particular a crankshaft, of a working device, in particular a vehicle, that is drivable by muscular power and/or by motor power about a rotational axis of the crankshaft, and designed with a surface structure that is materially and/or magnetically formed on a surface of the crankshaft, and a sensor unit that is designed to detect a magnetic field carried by the shaft and by the surface structure.

### FIELD

The present invention relates to a rotational speed and/or rotational angle detection unit and a working device. The present invention relates in particular to a torque detection device for in particular actively detecting a rotational speed and/or a rotational angle of a shaft, in particular a crankshaft, of a working device, in particular a vehicle, that is drivable by muscular power and/or by motor power about a rotational axis of the crankshaft, and a working device, a vehicle, a bicycle, an electric bicycle, an e-bike, a pedelec, or the like, that is drivable by muscular power and/or by motor power.

In the monitoring and/or control of drive devices, for example in the field of automotive engineering, it is often desirable to detect a rotational speed and/or a rotational angle, and thus an orientation, of an underlying shaft of a drive unit.

For this purpose, it is customary to use mechanical means, for example, for sampling a surface of the shaft in order to allow a rotational speed and/or a rotational angle, and thus an orientation of the shaft, to be deduced via a direct mechanical coupling.

The insufficient accuracy in the mechanical tapping and the influence of the mechanical tapping on the rotation and the orientation of the underlying shaft are disadvantageous.

### SUMMARY

The rotational speed and/or the rotational angle detection unit according to the present invention may have the advantage that without special mechanical precautions in the area of the shaft to be examined, a rotational speed and/or a rotational angle, and thus an orientation, of the underlying shaft may be ascertained with a high level of reliability and accuracy. This is achieved according to the present invention via the features in accordance with an example embodiment, in that a rotational speed and/or rotational angle detection unit for detecting a rotational speed and/or a rotational angle of a shaft, in particular a crankshaft, of a working device, in particular a vehicle, that is drivable about a rotational axis of the crankshaft by muscular power and/or or by motor power is provided, including (i) a surface structure that is materially and/or magnetically formed on a surface of the crankshaft, and (ii) a sensor unit that is designed to detect a magnetic field carried by the shaft and by the surface structure. By use of the measures according to the present invention, the rotational speed and/or the rotational angle of the underlying shaft and its rotational axis may be detected, without mechanical tapping and without mechanical coupling, by detecting magnetic signals at or in the shaft, and thus in a wear-free manner and with a higher level of accuracy.

By use of the measures according to the present invention and in particular by the contact-free detection of the rotational speed and the rotational angle, and thus of the time-dependent position of the shaft in relation to the rotational axis, a particularly high level of failure-free operation results for the measured value detection. In particular, the modulation of the magnetic field carried and/or emitted by the shaft via the surface structure is advantageously utilized, whether it is designed and configured mechanically and/or magnetically.

Preferred refinements and embodiments of the present invention are described herein.

According to one advantageous refinement of the rotational speed and/or rotational angle detection unit according to the present invention, a particularly high level of reliability in determining the rotational speed and/or the rotational angle of the shaft results when the surface structure is designed as an encoding item, in particular for an angular position of the crankshaft about the rotational axis. In this way, the orientation of the shaft in relation to the rotational axis of the shaft may be ascertained at any point in time, and the rotational speed of the shaft may also be determined from the time dependency of the orientation.

In general, there are numerous options for designing the surface structure on the surface of the underlying shaft. In general, all measures that are usable for a discrimination of the position of the shaft in relation to the rotational axis with angular resolution in the circumferential direction of the shaft may be used alone or in combination with one another.

In one particularly simple example embodiment of the rotational speed and/or the rotational angle detection unit according to the present invention, the surface structure is designed as a mechanical structure (i) including a sequence of elevations, depressions, and/or recesses, (ii) including a sequence of one or multiple ramp(s) with a particular edge at one end of the ramp, and/or (iii) as a knurl on or in the surface of the shaft, in each case in a circumferential direction of the shaft.

Alternatively, permanent magnetic encoding that is applied to the surface or incorporated into the surface may be present. This is possible, for example, in the sense of local permanent magnetic areas.

Magnetic structuring and mechanical structuring may be combined with one another.

The encoding may be applied in the surface and in the circumferential direction of the shaft by appropriate different lengths or angular extensions of the mechanical and/or magnetic areas.

To increase the sensitivity and thus the measuring accuracy, according to a further exemplary embodiment of the rotational speed and/or the rotational angle detection unit according to the present invention, it is provided that the sensor unit includes at least one receiver coil and/or a core, in particular containing or made of a ferromagnetic material, a particular receiver coil being designed as a measuring coil and/or a sensing coil.

Although a magnetic field that is inherently present in the shaft may be used in conjunction with the sensor unit for detecting the rotational angle and/or the rotational speed of the shaft, according to another preferred embodiment of the rotational speed and/or the rotational angle detection unit according to the present invention it is particularly advantageous when it is designed to actively detect the rotational speed and/or the rotational angle of the shaft, and for this purpose in particular is configured with an excitation unit that is designed to act on the shaft with a magnetic field that is in particular temporally variable.

In this regard, it is particularly advantageous when the excitation unit includes an exciter, in particular made up of or including a solenoid, with a core and/or containing or made of a ferromagnetic material.

Various configurations of excitation units are possible. In addition to explicitly providing a dedicated excitation unit, it is also possible to utilize devices that are designed in conjunction with other units and that are used to apply a magnetic field to the shaft to be measured.

Thus, in another preferred specific embodiment of the rotational speed and/or the rotational angle detection unit according to the present invention, the excitation unit is designed as a unit that is external to the sensor unit and/or as an excitation unit of a torque detection device.

In this specific embodiment, it is particularly advantageous that in a torque detection device that operates based on a magnetic field and is designed to actively act on the shaft with a magnetic field, an excitation unit, which is already present there by necessity, may also be utilized to generate the magnetic field with regard to the determination of the rotational speed and the rotational angle. Costs are thus saved, the number of necessary components is reduced, and a more compact design results for the actual rotational speed and/or rotational angle detection unit.

A particularly high level of compactness in the design of the rotational speed and/or the rotational angle detection unit according to the present invention may be achieved when the sensor unit, in particular a particular receiver coil of the sensor unit, and/or a particular exciter, in particular a particular solenoid of the excitation unit or of the exciter, are/is designed, at least in part, as a structure of a circuit board or conductor plate or a plurality of same.

For actually determining the values of the rotational speed and/or of the rotational angle of the underlying shaft, in one preferred embodiment of the rotational speed and/or the rotational angle detection unit according to the present invention an evaluation and control unit is provided that is configured to (i) receive values, representative of the detected magnetic fields, that are output by the sensor unit and (ii) determine the value of a rotational speed and/or of a rotational angle of the shaft, based on the received values.

Moreover, in the sense of an application, the present invention relates to a working device and in particular a vehicle that is drivable by muscular power and/or or by motor power, in particular a bicycle, an electric bicycle, an e-bike, a pedelec, or the like, including at least one wheel, a drive for driving the at least one wheel, and a rotational speed and/or a rotational angle detection unit designed according to the present invention for detecting a rotational speed and/or a rotational angle of a shaft of the drive, in which the drive is monitorable and/or controllable based on the detected rotational speed and/or the detected rotational angle.

### BRIEF DESCRIPTION OF THE DRAWINGS

Specific embodiments of the present invention are described in greater detail with reference to the figures.

FIGS. 1 through 3 show schematic views of various sides of one specific embodiment of the rotational speed and/or the rotational angle detection unit according to the present invention.

FIGS. 4 and 5 schematically show two views of another specific embodiment of the rotational speed and/or the rotational angle detection unit according to the present invention, in particular in cooperation with a provided torque detection device.

FIGS. 6 through 8 show various views of aspects of specific embodiments of the surface structure on or in the surface of the shaft, which may be based on the principle according to the present invention for detecting the rotational speed and the rotational angle.

FIG. 9 shows a perspective view of one specific embodiment of the rotational speed and/or the rotational angle detection unit according to the present invention in cooperation with a torque detection device.

FIG. 10 shows a schematic side view of one specific embodiment of a working device according to the present invention, in particular of a vehicle in the manner of an electric bicycle, using one specific embodiment of the rotational speed and/or the rotational angle detection unit according to the present invention.

### DETAILED DESCRIPTION OF EXAMPLE EMBODIMENTS

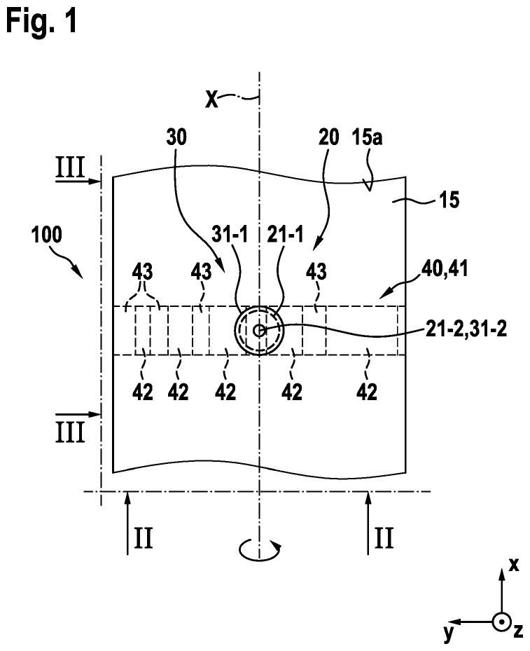

Exemplary embodiments of the present invention are described in greater detail below with reference to FIGS. 1 through 10. Elements and components that are identical and equivalent and that function in an identical or equivalent manner are denoted by the same reference numerals. A detailed description of the denoted elements and components is not provided in each case of their occurrence.

The described features and other properties may be arbitrarily separated from one another and arbitrarily combined with one another without departing from the core of the present invention.

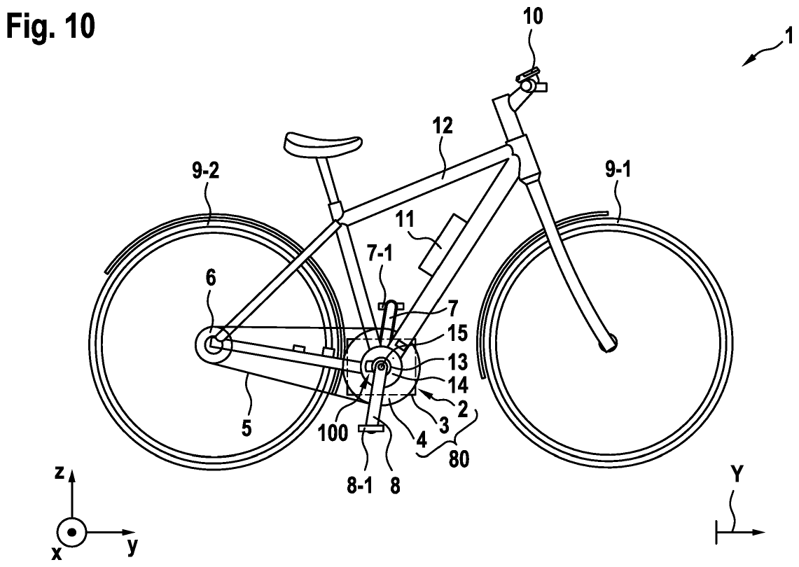

Initially, with reference to FIG. 10, an electric bicycle is described in greater detail by way of example as one preferred specific embodiment of the working device according to the present invention, in particular vehicle 1 according to the present invention.

Vehicle 1 as an electric bicycle includes a frame 12 at which a front wheel 9-1, a rear wheel 9-2, and a crank mechanism 2 that includes two cranks 7, 8 with pedals 7-1 and 8-1 are situated. An electric drive 3 is integrated into crank mechanism 2. A sprocket 6 is situated at rear wheel 9-2.

A drive torque that is provided by the rider and/or by electric drive 3 is transmitted from a chain ring 4 at crank mechanism 2 to sprocket 6 via a chain 5.

In addition, a control unit 10 that is connected to electric drive 3 is situated at the handlebars of vehicle 1. Furthermore, a battery 11 that is used to supply power to electric drive 3 is provided in or at frame 12.

In addition, a crank bearing 13 or bottom bracket ball bearing that includes a crank housing 14 and a crankshaft 15 is integrated into frame 12.

Thus, as a whole, drive 80 of vehicle 1 according to the present invention includes crank mechanism 2 for actuation by the rider with the aid of muscular power, and additional or alternative electric drive 3.

In addition, one specific embodiment of rotational speed and/or rotational angle detection unit 100 according to the present invention is provided in the area of drive 80 in order to detect the rotational speed and/or the rotational angle of crankshaft 15.

With reference to the tripod illustrated in FIG. 10, it is apparent that direction of longitudinal extension Y of the vehicle extends in parallel to the y direction, whereas the direction of transverse extension extends in parallel to the x direction and coincides with the direction of axis X of crankshaft 15.

FIGS. 1 through 3 show various views of one specific embodiment of rotational speed and/or rotational angle detection unit 100 according to the present invention.

The basic structure of rotational speed and/or rotational angle detection unit 100 is most easily discernible from the top view according to FIG. 1. In the figure, crankshaft 15 is illustrated as a shaft that may be acted on by a torque, and that is to be monitored with regard to the rotational speed and/or rotational angle. Crankshaft 15 is oriented in the x direction, and is rotatably supported about an axis X that is oriented in parallel to the x direction, as also illustrated in conjunction with FIG. 10 for vehicle 1 according to the present invention.

The specific embodiment of rotational speed and/or rotational angle detection unit 100 according to the present invention illustrated in FIG. 1 is made up of a sensor unit 30 and an excitation unit 20.

Sensor unit 30 is used as a measuring sensor device, or measuring sensor for short, and includes a receiver coil 31-1 that surrounds or encloses a core 31-2, for example containing or made of a ferromagnetic material.

An exciter 21 of an excitation unit 20, in particular in the form of a solenoid 21-1 that includes core 21-2 as part of excitation unit 20, is combined with receiver coil 31-1.

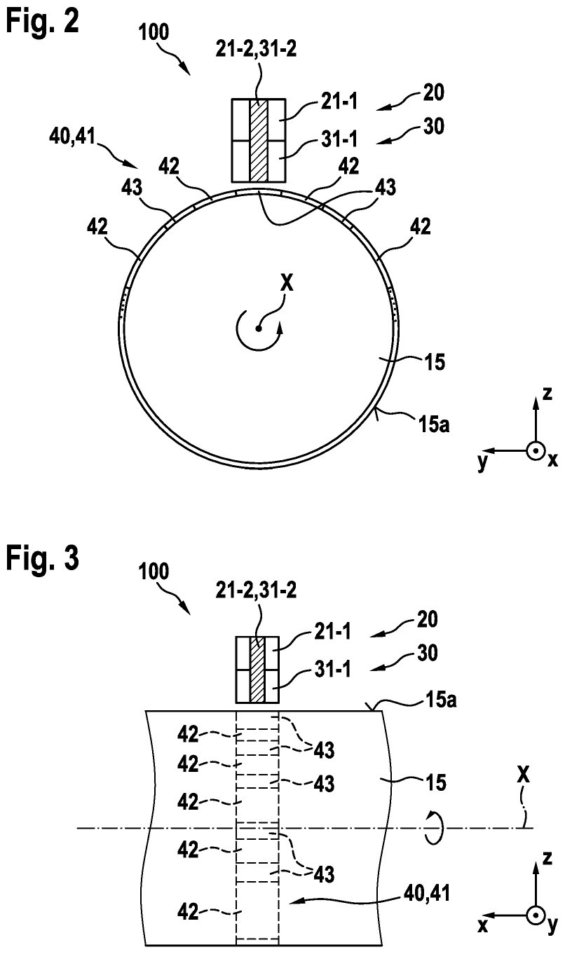

It is apparent from the illustrations in FIGS. 2 and 3 that receiver coil 31-1 of sensor unit 30 and solenoid 21-1 of excitation unit 20, designed coaxial and congruent with each other, are situated in the immediate vicinity of one another and are electrically decoupled from one another, and include a shared core 31-2, 21-2 that for example contains or is made of a ferromagnetic material.

Sensor unit 30 and excitation unit 20 are arranged and oriented in such a way that in a projection, the axes of coils 31-1, 21-1 and the axis of shared core 31-2, 21-2 are situated on the projection of rotational axis X. In this way, the magnetic field that is excited by excitation with the aid of excitation unit 20, and carried by shaft 15, may be detected in a particularly accurate manner.

FIGS. 2 and 3 show sectioned side views, along section planes II-II and III-III, respectively, of the arrangement of rotational speed and/or rotational angle detection unit 100 according to the present invention from FIG. 1.

It is clear from these illustrations that receiver coil 31-1 of sensor unit 30 and solenoid 21-1 of excitation unit 20 are associated with one another and include a shared core 21-2, 31-2, and that solenoid 21-2 of exciter 21 of excitation unit 20 is situated directly above associated receiver coils 31-1 of sensor unit 30, which functions as a measuring sensor.

Shaft 15 with surface 15a is situated in the immediate vicinity of receiver coil 31-1 and spaced apart from same, on the side of receiver coil 31-1 facing away from solenoid 21-2 of exciter 21 of excitation unit 20. The spatial distance from surface 15a is selected in such a way that the magnetic field that is excited by excitation unit 20 in shaft 15 and carried by shaft 15 may be detected in a particularly accurate manner.

A modulation of the magnetic field that is carried by shaft 15 and active at the location of sensor unit 20 is necessary for detecting the rotational speed and/or the rotational angle. This is achieved according to the present invention by forming a surface structure 40 on surface 15a of shaft 15 in the area which with the rotation of shaft 15 gets into the vicinity of sensor unit 20, and in particular of receiver coil 21-1.

In the specific embodiment shown in FIGS. 1 through 3, surface structure 40 is made up of an alternating sequence of elevations 42 and depressions 43, namely, in the manner of a circumferential knurl on surface 15a of shaft 15 in the circumferential direction.

In this way, sensor unit 30 measures the magnetic field carried by shaft 15 with a particularly high degree of sensitivity.

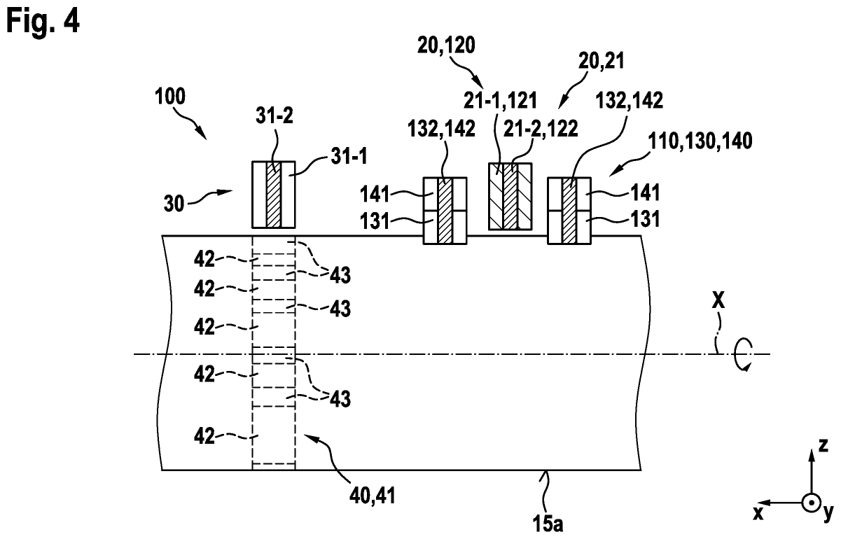

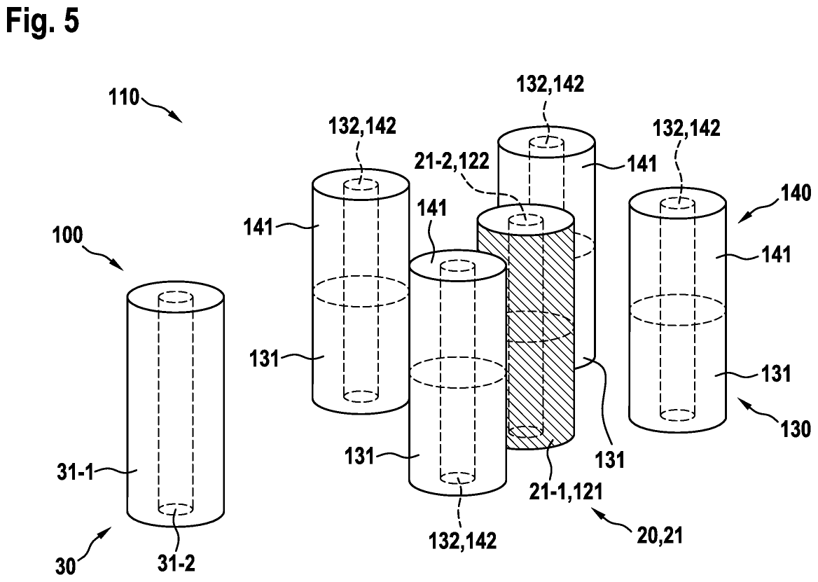

FIGS. 4 and 5 schematically show two views of another specific embodiment of rotational speed and/or rotational angle detection unit 100 according to the present invention, in particular in cooperation with a provided torque detection device 110.

An aspect of the specific embodiment in FIGS. 4 and 5 lies in utilizing an excitation unit 120, which is necessary for the functional principle of torque detection device 110, simultaneously as an excitation unit 20 for rotational speed and/or rotational angle detection unit 100 according to the present invention, i.e., as an excitation unit 20 that is provided externally to sensor unit 30 and its receiver coil 31-1.

The specific embodiment of rotational angle detection unit 110 shown here is based on the following key aspects:

In the specific embodiment of rotational speed and/or rotational angle detection unit 100 according to the present invention together with torque detection device 110 illustrated in FIGS. 4 and 5, torque detection device 100 is made up of a first sensor unit 130 and a second sensor unit 140.

First sensor unit 130 is used as a measuring sensor device, or measuring sensor for short, and includes four receiver coils 131 that may be situated, for example, at the end points of a vertical, flat cross that is provided with sides of equal length. An excitation unit 120 that includes a solenoid 121 with core 122 as part of an excitation unit 120 is situated in the center of the cross, i.e., the intersection point.

First sensor unit 130 as a measuring sensor device is oriented with its alignment cross in such a way that rotational axis X in a projection encloses an angle of 45 degrees with the sides of the alignment cross of first sensor unit 130. In this way, the magnetic field that is excited by excitation with the aid of excitation unit 120, and carried, by shaft 15 may be detected in a particularly accurate manner.

In addition to first sensor unit 130, it is possible, as shown in the specific embodiment in FIGS. 4 and 5, to provide a second sensor unit 140 having the same design as first sensor unit 130, but, with different electrical wiring, congruent with first sensor unit 130 and spatially slightly above same.

In this context, “congruent” means that both sensor units 130, 140 of torque detection device 110 have the same number of receiver coils 131 or 141, for example four, which are in a 1-to-1 association with one another, it being possible for mutually associated coils 131 and 141, as shown in this specific embodiment, to be situated coaxially and in the immediate spatial vicinity or proximity of one another, so that the end points, the sides, and also the intersection points of the particular crosses coincide, the intersection points in a projection onto one another being situated on rotational axis X or on the projection of same.

First sensor unit 130 and second sensor unit 140 from FIGS. 4 and 5 are thus situated with the same orientation in relation to one another and in relation to shaft 15, but are electrically wired differently with regard to their receiver coils 131, 141.

During operation, the two sensor units 130 and 140 of torque detection device 110 are excited by a shared excitation unit 120 that includes an exciter in the form of a solenoid 121 and a core 122 that is enclosed by solenoid 121, also facilitated by the field that is emitted from crankshaft 15. The exciter together with solenoid 121 is situated at, in, or in the area of the intersection point in such a way that a symmetrical arrangement made up of excitation unit 120 and sensor units 130, 140 of torque detection device 110 results overall.

It is clear from the illustrations in FIGS. 4 and 5 that receiver coils 131, 141, which are associated with one another, include a shared core 132, 142 in each case, i.e., in pairs, and that particular receiver coils 141 of second sensor unit 140 of torque detection device 110, which functions as a compensation sensor, are always situated directly above a particular associated receiver coil 131 of first sensor unit 130 of torque detection device 110, which functions as a measuring sensor.

In this way, first sensor unit 130 of torque detection device 110 measures the magnetic field carried by shaft 15 with a particularly high degree of sensitivity, including the interference signals, whereas second sensor unit 140 of torque detection device 110 receives these combined signals in the same way, but compensates for the interference signal components due to the different electrical economy circuit.

In addition, this procedure particularly advantageously allows a difference formation of the signals that are output by first and second sensor units 130 and 140 of torque detection device 110, optionally in a weighted and/or postprocessed form, to allow the interfering influences to be filtered out, and the effect on the carried magnetic field generated by the acting torque to be detected in a particularly accurate manner, in particular with the objective of determining the value of the acting torque in a preferably accurate and interference-free manner.

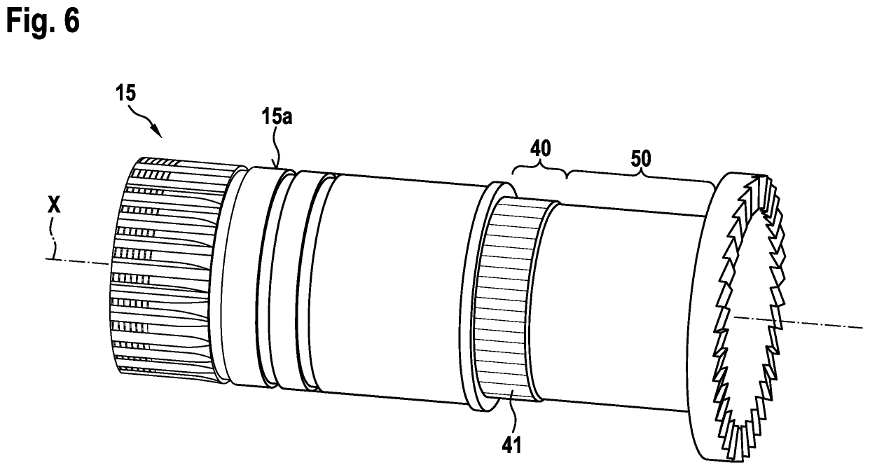

FIGS. 6 through 8 show various views of specific embodiments of surface structure 40 on or in surface 15a of shaft 15, which may be the basis for the principle according to the present invention for detecting the rotational speed and the rotational angle.

The illustration is selected in such a way that particular surface structure 40 on surface 15a appears to have an angled shape, i.e., planar, in each case corresponding to an unwound peripheral angle or roll-off angle α between 0° and 360°.

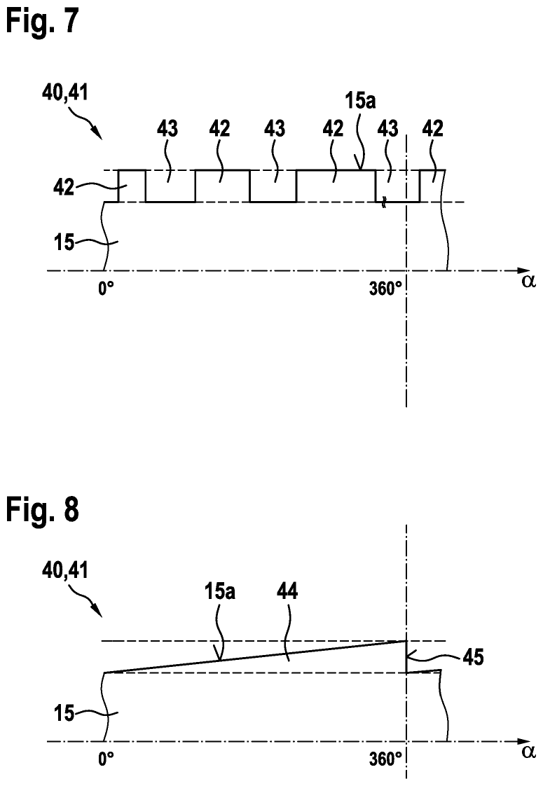

In the specific embodiment according to FIG. 7, surface structure 40 is designed in the manner of a knurl with elevations 42 and depressions or recesses 43 in surface 15a of shaft 15. The lengths of elevations 42 and/or of depressions/recesses 43 may be selected to be different in order to provide an encoding of the position on surface 15a, and thus an angular encoding with regard to the peripheral angle or roll-off angle α.

In the specific embodiment according to FIG. 8, knurl 41 of surface structure 40 is made up of a linear ramp 44 that includes an end flank or edge 45. By use of such a ramp 44, via the ramp height, angle α may be encoded as a function of the ramp height.

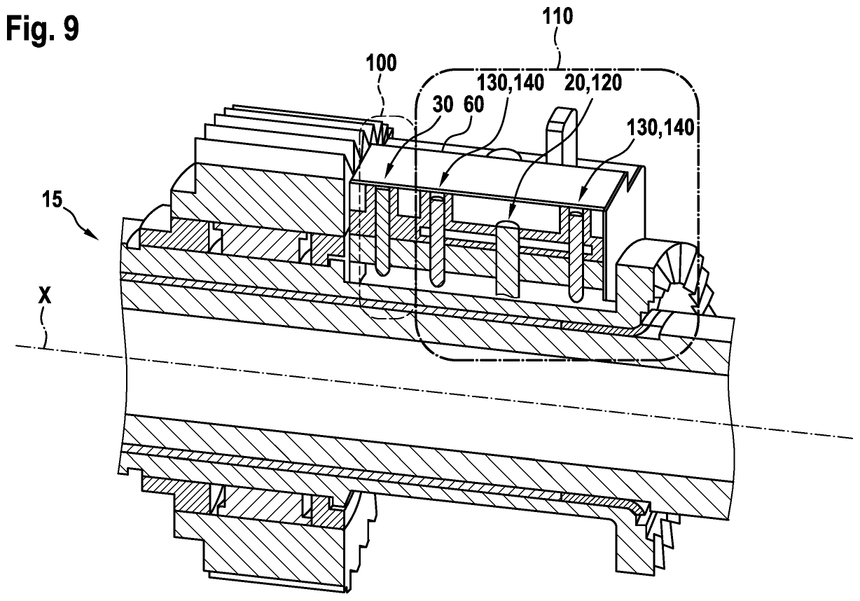

FIG. 9 shows a perspective view of one specific embodiment of rotational speed and/or rotational angle detection unit 100 according to the present invention, in particular once again in cooperation with a torque detection device 110 that endows excitation unit 20, 120.

It is apparent in particular from the illustration in FIG. 9 that rotational speed and/or rotational angle detection unit 100 according to the present invention, and excitation unit 20, 120 endowed by torque detection device 110 with first and second sensor units 130, 140, are accommodated in a shared spatial area, in particular in a shared shielding housing 60, where they magnetically access surface 15a of crankshaft 15 in order to detect the rotational speed and the rotational angle on the one hand, and the torque acting on shaft 15 on the other hand.

These and further features and properties of the present invention are explained in greater detail in the following discussion:

One aspect of the present invention lies in developing an active sensor for detecting the rotational speed and/or rotational angle at a stationary or rotating shaft. Examples of such rotating shafts are the crankshafts of bicycles, electric bicycles, e-bikes, pedelecs, or the like.

One intent of the present invention in particular is to achieve an improvement with regard to the susceptibility to interference with respect to the rotation of the shaft, for example due to a nonideal geometry of shaft 15, vibrations, mechanical and/or temperature changes, and the like.

A main feature of the present invention is to provide a surface structure 40 that is provided on or in surface 15a of underlying shaft 15 and used to modulate a carried magnetic field, inherently or actively generated by shaft 15, in such a way that a type of encoding for the rotational angle and/or for the rotational speed takes place.

An active magnetic measurement takes place at low working frequencies, in particular in the range of less than 5 kHz, preferably in the range of less than 3 kHz.

Analog and/or digital signal processing is used for improved signal resolution and to increase the signal-to-noise ratio. Temperature compensation is also possible here.

In one specific embodiment of the present invention, underlying excitation unit 20 may be formed from an excitation unit 120 of a cooperating torque detection device 110, which may be designed in particular with congruent first and second sensor units 130 and 140.

In this regard, first and second sensor units 130 and 140 may also be understood as two independent sensor heads, one for detection and one for compensation.

In conjunction with the figures, coil cores 121-2, 131-2, and 141-2 are shown with different geometries at the side facing shaft 15. This side, as an end surface, may be adapted planarly, convexly, circularly, conically, and/or locally to the surface shape of shaft 15, for example concavely in the manner of a section or cutout of the inner surface area of a circular cylinder and conforming to the outer surface area of shaft 15.

In one preferred specific embodiment of torque detection device 110, the following may be provided:
an excitation coil 21, 121 in the center,
four sensing coils 131 for first sensor unit 130, which in a projection are rotated or swiveled from shaft axis X at an angle of 45°,
electrical wiring for first sensor unit 130 connected in the manner of a Wheatstone bridge, and
four electromagnetic compensation coils in the form of receiver coils 141 for second sensor unit 140, which are spatially situated in a particular series connection via sensing coils 131 and in each case via same core 132 as sensing coils 131.
A core containing or made of a ferromagnetic material that connects all coils 131 and/or 141 to one another may be formed.
Sensing coils 131 detect signals from the torque and from the interferences.
Due to the particular wiring of compensation coils 141 in the manner of a series connection, they detect the interferences.
Via the magnetic coupling between sensing coils 131 and compensation coils 141, a compensation of the interferences already takes place on the “magnetic plane,” namely, via a mutual induction and/or via magnetically facilitating and coupling shared core 132, 142 of mutually associated coils 131, 141.
The separate rotational speed coil, namely, receiver coil 31-1 of sensor unit 30 of rotational speed and/or rotational angle detection unit 100 according to the present invention, in addition to excitation coil 121 of excitation unit 120 of rotational speed detection device 110, may also be designed with a dedicated, separate excitation coil 21-1 that is directly associated with rotational speed and/or rotational angle detection unit 100 and oriented in the axial direction.
This rotational speed coil 31-1 measures fluctuations of the magnetic field with the aid of an encoded surface 15a on shaft 15, for example in the form of an encoded knurl 41 that is applied to surface 15a of shaft 15 or introduced into surface 15a.
A miniaturization of the structure may be further optimized, so that the space requirements required for detecting disturbance variables coincide with the same surface that is necessary for sensing the torque.
In addition, by combining compensation coils 141 and sensing coils 131 of torque detection device 100 on a shared core 132, 142, the number of cores is reduced from 9 to 5. This also saves space, material, and costs.
The entire size of the sensor thus becomes much smaller, and the sensor may be easily integrated into any typical small environment without problems.
The entire electronics require approximately the same space as sensing coils and compensation coils 131, 141. Thus, no additional space requirements result.
Since the entire sensor may be designed using the most recent circuit board technology, the accuracy of the implementation, and thus small manufacturing tolerances, are in the range of the manufacturing tolerances of conductor plates or circuit boards using this manufacturing technology, i.e., in the micron range. This makes use in series production attractive.
A shielding plate 60 for reducing EMC interferences is optionally usable.

1-10. (canceled)

11. A rotational speed and/or rotational angle detection unit for detecting a rotational speed and/or a rotational angle of a crankshaft of a working device or a vehicle that is drivable by muscular power and/or by motor power about a rotational axis of the crankshaft, the rotational speed and/or rotational angle detection unit comprising:
a surface structure that is materially and/or magnetically formed on a surface of the crankshaft; and
a sensor unit configured to detect a magnetic field carried by the crankshaft and by the surface structure;
wherein the surface structure is configured as encoding for an angular position of the crankshaft about the rotational axis.

12. The rotational speed and/or rotational angle detection unit as recited in claim 11, wherein the surface structure is a mechanical structure: (i) including a sequence of elevations, and/or depressions, and/or recesses, and/or (ii) including a sequence of one or multiple ramps with a respective edge, and/or (iii) as a knurl on or in the surface of the crankshaft, in each case in a circumferential direction of the crankshaft.

13. The rotational speed and/or rotational angle detection unit as recited in claim 11, wherein the sensor unit includes at least one receiver coil and/or a core containing or made of a ferromagnetic material.

14. The rotational speed and/or rotational angle detection unit as recited in claim 13, wherein the receiver coil is a measuring coil and/or a sensing coil.

15. The rotational speed and/or rotational angle detection unit as recited in claim 11, which is configured to actively detect the rotational speed and/or the rotational angle, and includes an excitation unit configured to act on the crankshaft with a magnetic field that is temporally variable.

16. The rotational speed and/or rotational angle detection unit as recited in claim 15, wherein the excitation unit includes an exciter including a solenoid with a core and/or containing a ferromagnetic material.

17. The rotational speed and/or rotational angle detection unit as recited in claim 15, wherein the excitation unit a unit that is external to the sensor unit and/or is an excitation unit of a torque detection device.

18. The rotational speed and/or rotational angle detection unit as recited in claim 13, wherein the receiver coil of the sensor unit is a structure of at least one circuit board and/or conductor plate.

19. The rotational speed and/or rotational angle detection unit as recited in claim 16, wherein the exciter and in particular a particular solenoid of the excitation unit or of the exciter is a structure of at least one circuit board and/or conductor plate.

20. The rotational speed and/or rotational angle detection unit claim 11, further comprising:
an evaluation and control unit configured to receive values, representative of the detected magnetic field, output by the sensor unit, and determine a value of a rotational speed and/or of a rotational angle of the crankshaft, based on the received values.

21. A working device that is drivable with muscular power and/or or by motor power, the working device being a vehicle, or a bicycle, or an electric bicycle, or an e-bike, or a pedelec, comprising:
at least one wheel;
a drive configured to drive the at least one wheel; and
a rotational speed and/or rotational angle detection unit configured to detect a rotational speed and/or a rotational angle of a shaft of the drive, including:
a surface structure that is materially and/or magnetically formed on a surface of the shaft, and
a sensor unit configured to detect a magnetic field carried by the shaft and by the surface structure,
wherein the surface structure is configured as encoding for an angular position of the shaft about the rotational axis;
wherein the drive is monitorable and/or controllable based on the detected rotational speed and/or the detected rotational angle.
